(19) United States
(12) Patent Application Publication
(10) Pub. No.: US 2026/0323573 A1
(43) Pub. Date: Oct. 15, 2026

(54) METHODS FOR INDICATING SIDELINK REMOTE WIRELESS DEVICE DURING POSITIONING

(71) Applicant: Telefonaktiebolaget LM Ericsson (publ), Stockholm (SE)

(72) Inventors: Zhang FU, Stockholm (SE); Min WANG, Luleå (SE); Mohammed Yazid LYAZIDI, London (GB); Liwei QIU, Täby (SE); Richárd BÁTORFI, Budapest (HU); Ritesh SHREEVASTAV, Upplands Väsby (SE)

(21) Appl. No.: 19/119,174

(22) PCT Filed: Oct. 10, 2023
(86) PCT No.: PCT/IB2023/060176

§ 371 Date: Apr. 8, 2025

Related U.S. Application Data
(60) Provisional application No. 63/414,683, filed on Oct. 10, 2022.

(51) Int. Cl. H04W 64/00; H04W 88/04

(52) U.S. Cl. CPC H04W 64/00; H04W 88/04

(57) ABSTRACT

A method, network node and a wireless device (WD) for indicating sidelink remote WD during positioning are disclosed. According to one aspect, a method in a network node configured to operate a location management function (LMF) includes, when a relay status message indicating that a remote WD is connected with an L2 relay is received by the network node, selecting a positioning process to determine a position of the remote WD without assistance from a second network node operating as a radio base station.

### FIELD

The present disclosure relates to wireless communications, and in particular, to indicating sidelink remote wireless device (WD) during positioning.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

### Layer-2 WD-to-Network Relay

3GPP Technical Standard (TS) 23.304 specifies the Open Systems Interconnection (OSI) Layer-2 (referred to herein simply as “Layer-2” and “L2”) WD-to-Network communication in the following: 5G ProSe Communication via 5G ProSe Layer-2 WD-to-Network Relay;

### Registration and Connection Management;

### Registration Management:

Registration Management for the 5G Proximity Services (ProSe) Layer-2 Remote WD and the 5G ProSe Layer-2 WD-to-Network Relay follows the principles and procedures defined in 3GPP TS 23.501 and 3GPP TS 23.502. The 5G ProSe Layer-2 Remote WD and the 5G ProSe Layer-2 WD-to-Network Relay may be served by the same Access and Mobility Management Function (AMF) or different AMFs.

### Connection Management

Connection Management for the 5G ProSe Layer-2 Remote WD and the 5G ProSe Layer-2 WD-to-Network Relay follows the principles and procedures defined in 3GPP TS 23.501 and 3GPP TS 23.502 with the following modifications.

The 5G ProSe Layer-2 WD-to-Network Relay may only relay data/signaling for the 5G ProSe Layer-2 Remote WD(s) when the 5G ProSe Layer-2 WD-to-Network Relay is in CM-CONNECTED state. If the 5G ProSe Layer-2 WD-to-Network Relay is in CM_IDLE state and receives a connection request from the 5G ProSe Layer-2 Remote WD for relaying, the 5G ProSe Layer-2 WD-to-Network Relay shall trigger the Service Request procedure to enter CM_CONNECTED state before relaying the 5G ProSe Layer-2 Remote WDs traffic.

The state of 5G ProSe WD-to-Network Relay is controlled by NG-radio access network (RAN) with the following:
If any 5G ProSe Layer-2 Remote WD connected to the 5G ProSe Layer-2 WD-to-Network Relay is in CM-CONNECTED with radio resource control (RRC) Connected state, the 5G ProSe Layer-2 WD-to-Network Relay shall remain CM-CONNECTED state with radio resource control (RRC) Connected state unless the network needs to release the connection; and
If all 5G ProSe Layer-2 Remote WDs connected to the 5G ProSe Layer-2 WD-to-Network Relay enter CM-IDLE or CM-CONNECTED with RRC Inactive state, the 5G ProSe Layer-2 WD-to-Network Relay may enter CM-IDLE state or CM-CONNECTED with RRC Inactive state, or may remain CM-CONNECTED with RRC Connected state.

When 5G ProSe Layer-2 Remote WD is in CM-CONNECTED state, the 5G ProSe Layer-2 WD-to-Network Relay and 5G ProSe Layer-2 Remote WD keep the PC5 link. When the 5G ProSe Remote WD is in CM-IDLE state, it may either release the PC5 link for relaying or not.

Paging a 5G ProSe Layer-2 Remote WD follows the principles and procedures defined in 3GPP TS 23.501 and 3GPP TS 23.502, and the paging message delivery from NG-RAN to 5G ProSe Layer-2 Remote WD is specified in 3GPP TS 38.300.

### Connection Establishment

The following steps are involved in connection establishment, as described with reference to FIG. 1.
0. If in coverage, the 5G ProSe Layer-2 Remote WD and 5G ProSe Layer-2 WD-to-Network Relay may independently perform the initial registration to the network according to registration procedures in 3GPP TS 23.502.
1. If in coverage, the 5G ProSe Layer-2 Remote WD and 5G ProSe Layer-2 WD-to-Network Relay independently get the service authorization for 5G ProSe Layer-2 WD-to-Network Relay operation from the network. Service authorization and parameters provisioning for 5G ProSe Layer-2 WD-to-Network Relay operation are performed for the 5G ProSe Layer-2 WD-to-Network Relay and 5G ProSe Layer-2 Remote WD as specified in clause 5.1.4 of 3GPP TS 38.300.

If the 5G ProSe Layer-2 Remote WD is not in coverage, the pre-configured parameters are used, and the service authorization and parameters may be updated after step 6.

If the 5G ProSe Layer-2 Remote WD has not performed Initial Registration, the 5G ProSe Layer-2 Remote WD may perform the Initial Registration in step 6.
2. The 5G ProSe Layer-2 Remote WD and 5G ProSe Layer-2 WD-to-Network Relay perform 5G ProSe WD-to-Network Relay Discovery and selection, as specified in clause 6.3.2.3 of 3GPP TS 38.300.
3. The 5G ProSe Layer-2 Remote WD initiates a one-to-one communication connection with the selected 5G ProSe Layer-2 WD-to-Network Relay over PC5 using the procedure as described in clause 6.4.3 of 3GPP TS 38.300.
4. The 5G ProSe Layer-2 Remote WD establishes an RRC Connection with the same NG-RAN serving the selected 5G ProSe Layer-2 WD-to-Network Relay, specified in 3GPP TS 38.300.
5. During step 4, if the 5G ProSe Layer-2 WD-to-Network Relay is in CM_IDLE state and receives a trigger from the AS layer to enter CM-CONNECTED state due to Remote WD's AS layer connection set up with the NG-RAN, the 5G ProSe Layer-2 WD-to-Network Relay performs Service Request procedure in the clause 4.2.3.2 of 3GPP TS 23.502.
6. The 5G ProSe Layer-2 Remote WD sends a non-access stratum (NAS) message to the serving AMF. The NAS message is encapsulated in an Uu RRC message that is sent over PC5 to the 5G ProSe Layer-2 WD-to-Network Relay, and the 5G ProSe Layer-2 WD-to-Network Relay forwards the Uu RRC message to the NG-RAN specified in 3GPP TS 38.300. NG-RAN selects the 5G ProSe Layer-2 Remote WD's serving AMF and forwards the NAS message to this AMF.

If the 5G ProSe Layer-2 Remote WD has not performed the initial registration, the NAS message is an initial Registration message. Otherwise, the NAS message is either a service request message, or a mobility or periodic Registration message taking into account the TAI in the RRC container received from the 5G ProSe Layer-2 WD-to-Network Relay during Relay Discovery (see clause 5.8.3.3) or PC5-RRC message, as specified in 3GPP TS 38.300.
7. The 5G ProSe Layer-2 Remote WD may trigger the PDU Session Establishment procedure as defined in clause 4.3.2.2 of 3GPP TS 23.502.
8. The data is transferred between the 5G ProSe Layer-2 Remote WD and UPF via the 5G ProSe Layer-2 WD-to-Network Relay and NG-RAN. The 5G ProSe Layer-2 WD-to-Network Relay forwards all the data messages between the 5G ProSe Layer-2 Remote WD and NG-RAN, as specified in 3GPP TS 38.300.

### 5G ProSe Layer-2 WD-to-Network Relay

The WD-WD protocol stacks for discovery and PC5 signaling defined in clause 6.1.1.2 of 3GPP TS 38.3 apply to 5G ProSe Remote WD and 5G ProSe Layer-2 WD-to-Network Relay.

FIG. 2 illustrates the protocol stack of the NAS connection for the 5G ProSe Layer-2 Remote WD for non-access stratum-mobility management (NAS-MM) and NAS-session management (NAS-SM). The NAS messages are transparently transferred between the 5G ProSe Layer-2 Remote WD and NG-RAN over the 5G ProSe Layer-2 WD-to-Network Relay using:
Packet Data Convergence Protocol (PDCP) end-to-end connection between the 5G ProSe Layer-2 Remote WD and NG-RAN, where the role of the 5G ProSe Layer-2 WD-to-Network Relay is to relay the packet data units (PDUs) over the signalling radio bear without any modifications and using the functionality of the adaptation layer as specified in 3GPP TS 38.300;
Connection between NG-RAN and AMF over N2; and
Connection between AMF and SMF over N11.

The control plane protocol stack used by the 5G ProSe Layer-2 WD-to-Network Relay is defined in clause 8.2.2 of 3GPP TS 23.501.

### 5G ProSe Layer-2 WD-to-Network Relay

FIG. 3 illustrates the protocol stack for the user plane transport, related to a PDU Session, including a 5G ProSe Layer 2 WD-to-Network Relay. The PDU layer corresponds to the PDU carried between the 5G ProSe Layer-2 Remote WD and the Data Network (DN) over the PDU session. The Service Data Adaptation Protocol (SDAP) and PDCP protocols are specified in 3GPP TS 38.300. A PDCP end-to-end connection is between the 5G ProSe Layer-2 Remote WD and NG-RAN. The functionality of the adaptation layer is specified in 3GPP TS 38.351.

### Mobile Termination-Location Request (MT-LR) Position

3GPP TS 23.273 defines the MT-LR positioning procedure as the following:

### WD Assisted and WD Based Positioning Procedure

FIG. 4 shows a positioning procedure used by a Location Management Function (LMF) to support WD based positioning, WD assisted positioning and delivery of assistance data. The procedure is based on use of the LTE Positioning Protocol (LPP) protocol defined in 3GPP TS 37.355 between the LMF and WD.

Precondition: A Location Services (LCS) Correlation identifier and the AMF identity have been passed to the LMF by the serving AMF.
1. The LMF invokes the Namf_Communication_N1N2MessageTransfer service operation towards the AMF to request the transfer of a Downlink (DL) Positioning message to the WD. The service operation includes the DL Positioning message. The Session ID parameter of the Namf_Communication_N1N2MessageTransfer service operation is set to the LCS Correlation identifier. The Downlink Positioning message may request location information from the WD, provide assistance data to the WD or query for the WD capabilities if the WD Positioning Capability is not received from AMF.
2. If the WD is in CM IDLE state, the AMF initiates a network triggered Service Request procedure as defined in clause 4.2.3.3 of 3GPP TS 23.502 to establish a signalling connection with the WD.
3. The AMF forwards the Downlink Positioning message to the WD in a DL NAS TRANSPORT message. The AMF includes a Routing identifier, in the DL NAS TRANSPORT message, which is set to the LCS Correlation identifier. The Downlink Positioning message may request the WD to response to the network, e.g., may request the WD to acknowledge the Downlink Positioning message, to return location information or to return capabilities, as defined in 3GPP TS 37.355.
4. The WD stores any assistance data provided in the Downlink Positioning message and performs any positioning measurements and/or location computation requested by the Downlink Positioning message.
5. If the WD has entered CM-IDLE state during step 4 and needs to responses to the request received in step 3, the WD instigates the WD triggered Service Request as defined in clause 4.2.3.2 of 3GPP TS 23.502 in order to establish a signalling connection with the AMF.
6. [Conditional] The WD sends to the AMF the Uplink Positioning message included in a NAS TRANSPORT message, e.g., to acknowledge the Downlink Positioning message, to return any location information obtained in step 4 or returns any capabilities, as requested in step 3. When the WD sends Uplink Positioning message in a NAS TRANSPORT message, the WD shall also include in the UL NAS TRANSPORT message the Routing identifier received in step 3.
7. [Conditional] The AMF invokes the Namf_Communication_N1MessageNotify service operation towards the LMF indicated by the routing identifier received in step 6. The service operation includes the Uplink Positioning message received in step 6 and the LCS Correlation identifier. Steps 6 and 7 may be repeated if the WD needs to send multiple Uplink Positioning messages to respond to the request received in Step 3. Steps 1 to 7 may be repeated to send new assistance data, and to request further location information and further WD capabilities.

### Network Assisted Positioning Procedure

FIG. 5 shows a procedure that may be used by an LMF to support network assisted and network based positioning. The procedure may be based on an NRPPa protocol in 3GPP TS 38.455 between the LMF and NG-RAN.

Precondition: A LCS Correlation identifier and the AMF identity have been passed to the LMF by the serving AMF.
1. The LMF invokes the Namf_Communication_N1N2MessageTransfer service operation towards the AMF to request the transfer of a Network Positioning message to the serving NG-RAN node (gNB or ng-eNB) for the WD. The service operation includes the Network Positioning message and the LCS Correlation identifier. The Network Positioning message may request location information for the WD from the NG-RAN.
2. If the WD is in CM IDLE state, the AMF initiates a network triggered Service Request procedure as defined in clause 4.2.3.3 of 3GPP TS 23.502, to establish a signalling connection with the WD.
3. The AMF forwards the Network Positioning message to the serving NG-RAN node in an N2 Transport message. The AMF includes a Routing identifier, in the N2 Transport message, identifying the LMF (e.g., a global address of the LMF).
4. The serving NG-RAN node obtains any location information for the WD requested in step 3.
5. The serving NG-RAN node returns any location information obtained in step 4 to the AMF in a Network Positioning message included in an N2 Transport message. The serving NG-RAN node shall also include the Routing identifier in the N2 Transport message received in step 3.
6. The AMF invokes the Namf_Communication_N2InfoNotify service towards the LMF indicated by the routing identifier received in step 5. The service operation includes the Network Positioning message received in step 5 and the LCS Correlation identifier. Steps 1 to 6 may be repeated to request further location information and further NG-RAN capabilities.

### Obtaining Non-WD Associated Network Assistance Data

FIG. 6 shows an example procedure which may be used by an LMF to support network assisted and network based positioning. This procedure is not associated with a WD location session. It is used to obtain network assistance data from a NG-RAN node (e.g., gNB or ng-eNB). The procedure may be based on an NRPPa protocol in 3GPP TS 38.455 between the LMF and NG-RAN.
1. The LMF invokes the Namf_Communication_NonUeN2MessageTransfer service operation towards the AMF to request the transfer of a Network Positioning message to a NG-RAN node (gNB or ng-eNB) in the NG-RAN. The service operation includes the Network Positioning message and the target NG-RAN node identity. The Network Positioning message may request position related information from the NG-RAN.
2. The AMF forwards the Network Positioning message to the target NG-RAN node indicated in step 1 in an N2 Transport message. The AMF includes a Routing identifier, in the N2 Transport message, identifying the LMF.
3. The target NG-RAN node obtains any position related information requested in step 2.
4. The target NG-RAN node returns any position related information obtained in step 3 to the AMF in a Network Positioning message included in an N2 Transport message. The target NG-RAN node shall also include the Routing identifier in the N2 Transport message received in step 2.
5. The AMF invokes the Namf_Communication_NonUeN2InfoNotify service operation towards the LMF indicated by the routing identifier received in step 4. The service operation includes the Network Positioning message received in step 4. Steps 1 to 5 may be repeated to request further position related information from the NG-RAN.

In the current 3GPP standard, when a WD is connected to the network via a Layer-2 WD-to-Network relay, the WD has its own end to end (E2E) connection to the gNB and the core network established via the L2 U2N relay. In such case, the 5GC has no knowledge on whether the WD's E2E connection is maintained via a direct gNB-Uu connection or via a L2 U2N WD relay connection. When MT-LR procedure is triggered, AMF and LMF have no idea if the target remote WD for positioning is connected via a L2 WD-to-Network relay or it has direct Uu connection with the network node, e.g., gNB. Therefore, it may happen that MT-LR positioning cannot be done, since the network node, e.g., gNB, and the remote WD cannot perform the legacy RAN-based positioning or that the legacy RAN (Uu) positioning methods will not work properly when trying to position the remote WD connected via the L2 U2N relay WD.

### SUMMARY

Some embodiments advantageously provide methods, network nodes and wireless devices (WDs) for indicating sidelink remote WD during positioning.

Some embodiments provide a mechanism whereby the AMF/LMF identifies whether a WD is being served by relay WD; i.e., if the WD is an out of coverage/remote WD.

Regarding WD assisted positioning, in some embodiments, the LMF sends a positioning message to the L2 U2N remote WD, and the remote WD sends an UL position message saying it is connected with an L2 relay, so it cannot do positioning with the network node, e.g., gNB. The LMF may decide to use other positioning techniques, e.g., use relay position to estimate the remote WD's closest position and/or for the LMF to switch to sidelink based positioning methods.

Regarding network assisted positioning, in some embodiments, the LMF sends a position message to the NG-RAN, and the NG-RAN knows that the remote WD is connected with an L2 relay WD. The NG-RAN may inform the LMF that the remote WD is connected with an L2 relay WD, so it cannot do positioning with the gNB. The LMF may decide to use other position techniques, e.g., use relay WD position to estimate the remote WD's closest position and/or for the LMF to switch to sidelink based positioning methods.

Some embodiments include methods for signaling that position the remote WD when the positioning cannot be done via RAN-based positioning (Radio access Technology RAT dependent positioning) due to connection with a relay U2N WD; the LMF instead considers sidelink (SL) measurements for positioning the remote WD. Some advantages of some embodiments may include, but are not limited to:
1. Achieving observability/awareness at the 5G core network nodes (AMF or LMF) that that WD is a remote WD and that it cannot be positioned using RAN based positioning methods with Uu measurements; and/or
2. Providing key performance indicators (KPI) at the LMF to measure what percentage of WDs are remote WDs which require positioning.

According to one aspect, a first network node configured to communicate with a wireless device, WD, is provided. The first network node is configured to operate a location management function, LMF, and is configured to, when a relay status message indicating that a remote WD is connected with an L2 relay is received by the network node, select a positioning process to determine a position of the remote WD without assistance from a second network node operating as a radio base station.

According to this aspect, in some embodiments, the selected positioning process includes determining a position of a relay WD and estimating a position of the remote WD based at least in part on the position of the relay WD. In some embodiments, the network node is configured to determine when the position of the relay WD may be used to estimate the position of the remote WD, based at least in part on at least one of position measurements, channel quality measurements of a sidelink channel between the remote WD and the relay WD, and a proximity indicator. In some embodiments, the estimated position of the remote WD is the position of the relay WD plus an offset. In some embodiments, selecting the positioning process includes switching to a sidelink based positioning method. In some embodiments, the network node is configured to transmit position information to enable the remote WD to determine whether a position of a relay WD is to be used to estimate a position of the remote WD. In some embodiments, the relay status message is received from a radio access node. In some embodiments, the relay status message includes an indication of signal power of a sidelink connection between the remote WD and a relay WD. In some embodiments, the network node is configured to determine one or both of a positioning accuracy and a positioning quality of service based at least in part on the signal power indication. In some embodiments, the network node receives the relay status message via an access and mobility management function, AMF, from the second network node operating as the radio base station.

According to another aspect, a method in a first network node configured to communicate with a wireless device, WD, is provided. The network node is configured to operate a location management function, LMF. The method includes, when a relay status message indicating that a remote WD is connected with an L2 relay is received by the network node, selecting a positioning process to determine a position of the remote WD without assistance from a second network node operating as a radio base station.

According to this aspect, in some embodiments the selected positioning process includes determining a position of a relay WD and estimating a position of the remote WD based at least in part on the position of the relay WD. In some embodiments, the method includes determining when the position of the relay WD may be used to estimate the position of the remote WD, based at least in part on at least one of position measurements, channel quality measurements of a sidelink channel between the remote WD and the relay WD, and a proximity indicator. In some embodiments, the estimated position of the remote WD is the position of the relay WD plus an offset. In some embodiments, selecting the positioning process includes switching to a sidelink based positioning method. In some embodiments, the method includes transmitting position information to enable the remote WD to determine whether a position of a relay WD is to be used to estimate a position of the remote WD. In some embodiments, the relay status message is received from a radio access node. In some embodiments, the relay status message includes an indication of signal power of a sidelink connection between the remote WD and a relay WD. In some embodiments, the method includes determining one or both of a positioning accuracy and a positioning quality of service based at least in part on the signal power indication. In some embodiments, the method includes receiving the relay status message via an access and mobility management function, AMF, from the second network node operating as the radio base station.

According to yet another aspect, a first wireless device (WD) configured to communicate with a network node in communication with a location management function (LMF) is provided. The first WD is configured to: transmit to the network node a relay status message indicating whether a remote WD is connected with an L2 relay; and receive from the network node a positioning process for determining a position of the first WD.

According to this aspect, in some embodiments, the relay status message is based at least in part on a comparison of radio quality to a first threshold. In some embodiments, the relay status message is based at least in part on a comparison of a distance to a second threshold. In some embodiments, the network node includes a radio base station. In some embodiments, the first WD is a relay WD.

According to another aspect, a method in a first wireless device (WD) configured to communicate with a network node in communication with a location management function (LMF) is provided. The method includes transmitting to the network node a relay status message indicating whether a remote WD is connected with an L2 relay; and receiving from the network node a positioning process for determining a position of the first WD.

According to this aspect, in some embodiments, the relay status message is based at least in part on a comparison of radio quality to a first threshold. In some embodiments, the relay status message is based at least in part on a comparison of a distance to a second threshold. In some embodiments, the network node includes a radio base station. In some embodiments, the first WD is a relay WD.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a connection establishment process;

FIG. 2 illustrates a protocol stack of a non-access stratum for the 5G ProSe layer 2 remote WD for NAS-MM and NAS-SM;

FIG. 3 illustrates a protocol stack for a user plane transport;

FIG. 4 is a diagram of a positioning procedure used by a location management function (LMF) to support WD based positioning, WD assisted positioning and delivery of assistance data;

FIG. 5 is a diagram of a first procedure for an LMF to support network assisted and network based positioning;

FIG. 6 is a diagram of a second procedure for an LMF to support network assisted and network based positioning;

FIG. 7 is a schematic diagram of an example network architecture illustrating a communication system connected via an intermediate network to a host computer according to the principles in the present disclosure;

FIG. 8 is a block diagram of a host computer communicating via a network node with a wireless device over an at least partially wireless connection according to some embodiments of the present disclosure;

FIG. 9 is a flowchart illustrating example methods implemented in a communication system including a host computer, a network node and a wireless device for executing a client application at a wireless device according to some embodiments of the present disclosure;

FIG. 10 is a flowchart illustrating example methods implemented in a communication system including a host computer, a network node and a wireless device for receiving user data at a wireless device according to some embodiments of the present disclosure;

FIG. 11 is a flowchart illustrating example methods implemented in a communication system including a host computer, a network node and a wireless device for receiving user data from the wireless device at a host computer according to some embodiments of the present disclosure;

FIG. 12 is a flowchart illustrating example methods implemented in a communication system including a host computer, a network node and a wireless device for receiving user data at a host computer according to some embodiments of the present disclosure;

FIG. 13 is a flowchart of an example process in a network node for indicating sidelink remote wireless device (WD) during positioning;

FIG. 14 is a flowchart of an example process in a wireless device for indicating sidelink remote wireless device (WD) during positioning;

FIG. 15 is a flowchart of an example process in a network node for indicating sidelink remote wireless device (WD) during positioning;

FIG. 16 is a flowchart of an example process in a wireless device for indicating sidelink remote wireless device (WD) during positioning;

FIG. 17 is a timing diagram of an example process for WD-assisted positioning; and

FIG. 18 is a timing diagram of an example process for network assisted positioning.

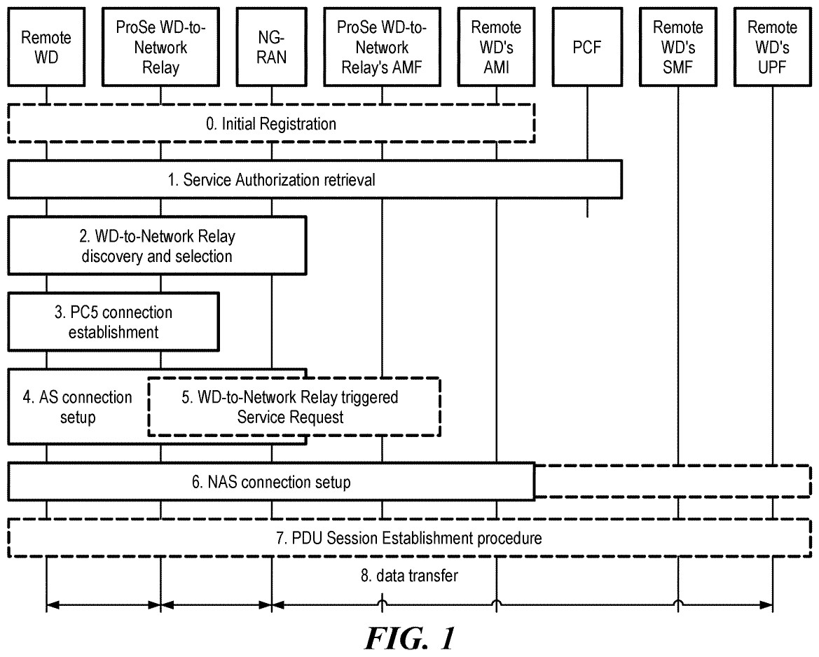

### DETAILED DESCRIPTION

Before describing in detail example embodiments, it is noted that the embodiments reside primarily in combinations of apparatus components and processing steps related to indicating sidelink remote wireless device (WD) during positioning. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections. As an example, transmission from a WD to an LMF or vice versa may be via intermediate devices or nodes.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node. The term “network node” may also refer to a core network node that includes a location management function (LMF) and/or an access and mobility management function (AMF).

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

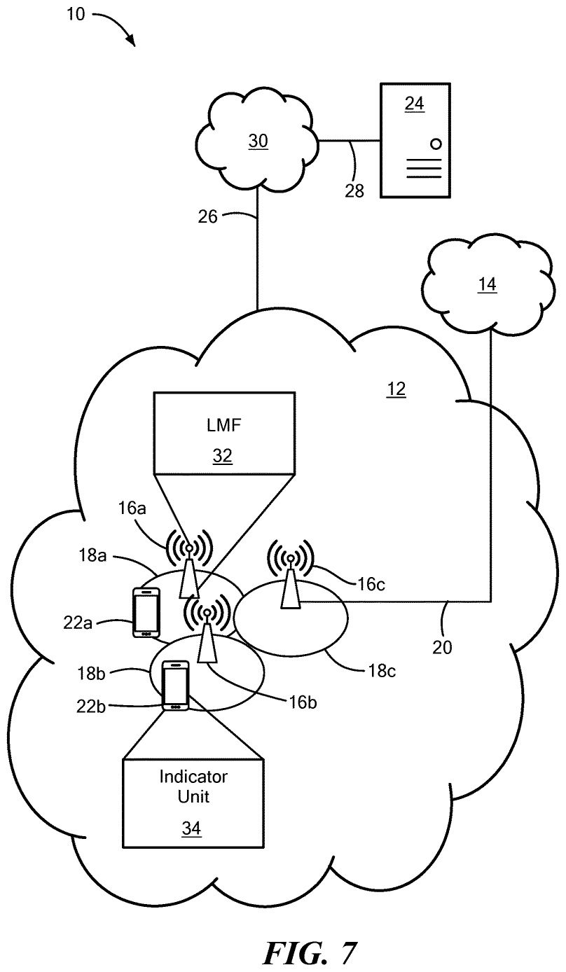

Some embodiments provide for indicating sidelink remote wireless device (WD) during positioning. Returning now to the drawing figures, in which like elements are referred to by like reference numerals, there is shown in FIG. 7 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Note that a network node 16 in some embodiments may operate a location management function (LMF) or may operate as a next generation radio access node (NG-RAN) or may operate as a gNB. In some embodiments, a network node 16a configured to operate an LMF (or as an LMF) to select a positioning process to determine a position of the remote WD 22a without assistance from a gNB 16b, when a relay status message indicates that the remote WD 22a is connected with an L2 relay. Thus, a WD 22 may be operate as a remote WD 22a and/or as a relay WD 22b. In some embodiments, a remote WD 22a or a relay WD 22b may indicate to a network node 16 whether the position of the relay WD 22b may be used to determine the position of the remote WD 22a. Note that the LMF may be located in a core network node or a radio base station, for example. The remote WD 22a and the relay WD 22b may communicate with each other via a sidelink channel.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a network node 16, e.g., gNB, for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 7 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an LMF 32 which is configured to, when a relay status message indicating the remote WD is connected with an L2 relay is received by the network node, select a positioning process to determine a position of the remote WD without assistance from a gNB. A first wireless device 22a, 22b, is configured to include an indicator unit 34 which is configured to indicate whether a position of a relay WD 22b may be used by the network node to represent a position of the first WD 22, 22b.

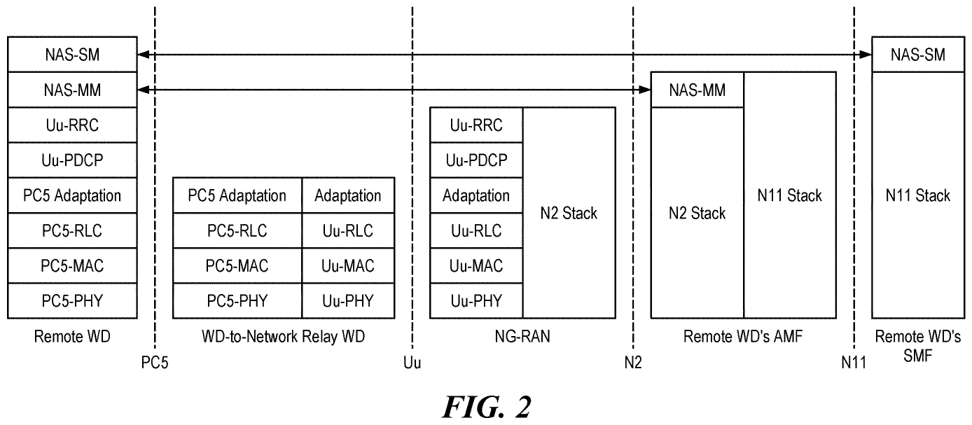

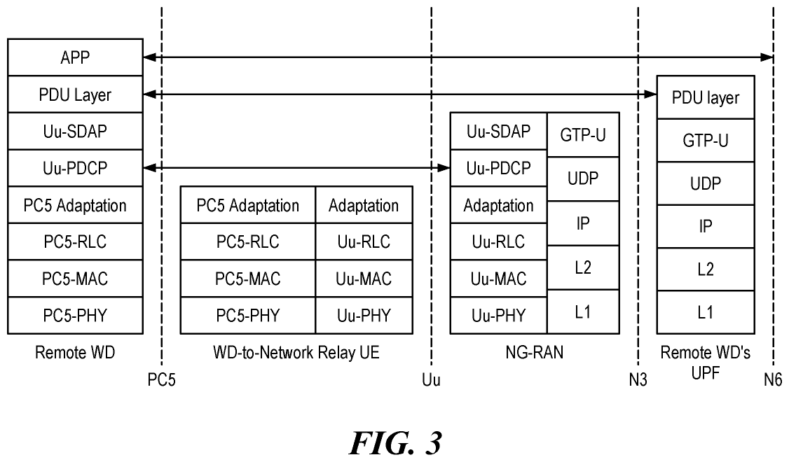

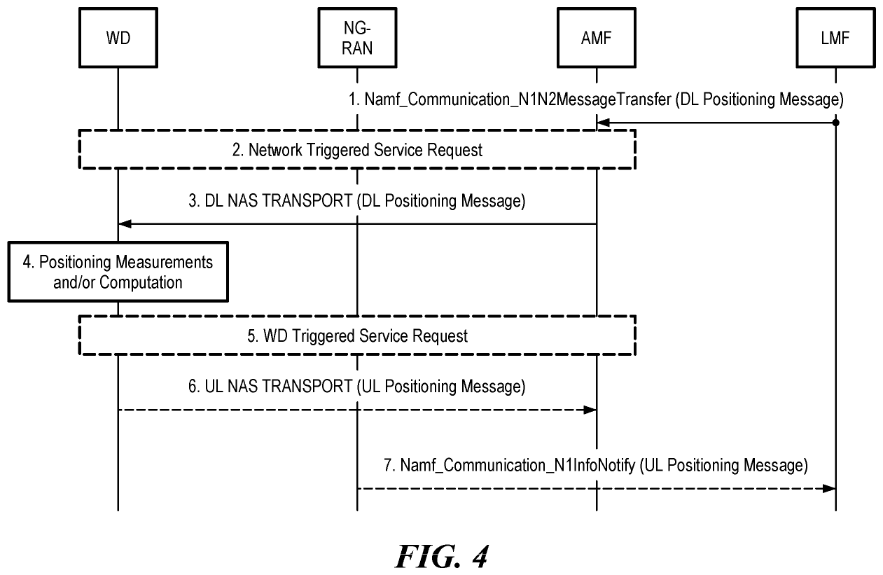

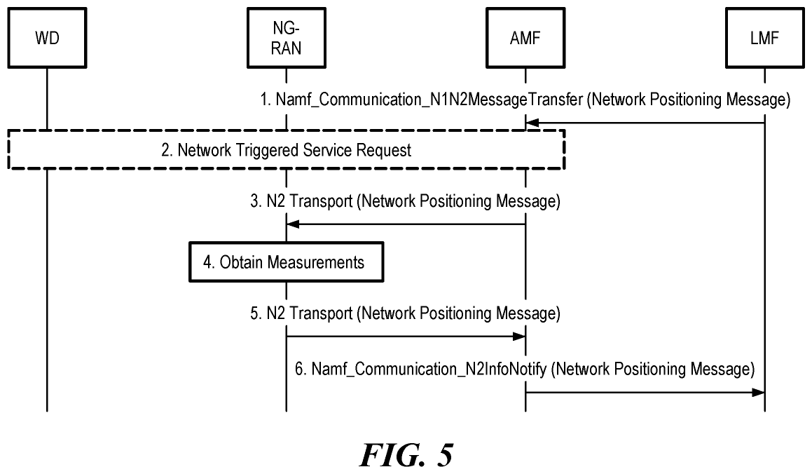

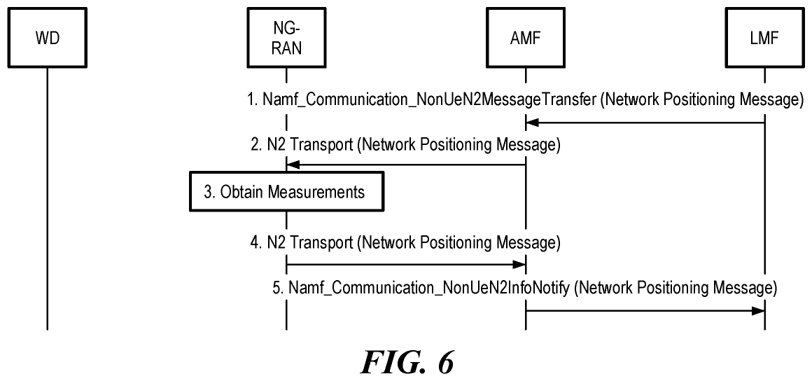

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In some embodiments, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include an LMF 32 which is configured to, when a relay status message indicating the remote WD is connected with an L2 relay is received by the network node, select a positioning process to determine a position of the remote WD without assistance from a gNB.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an indicator unit 34 configured to indicate whether a position of a relay WD may be used by the network node to represent a position of the first WD.

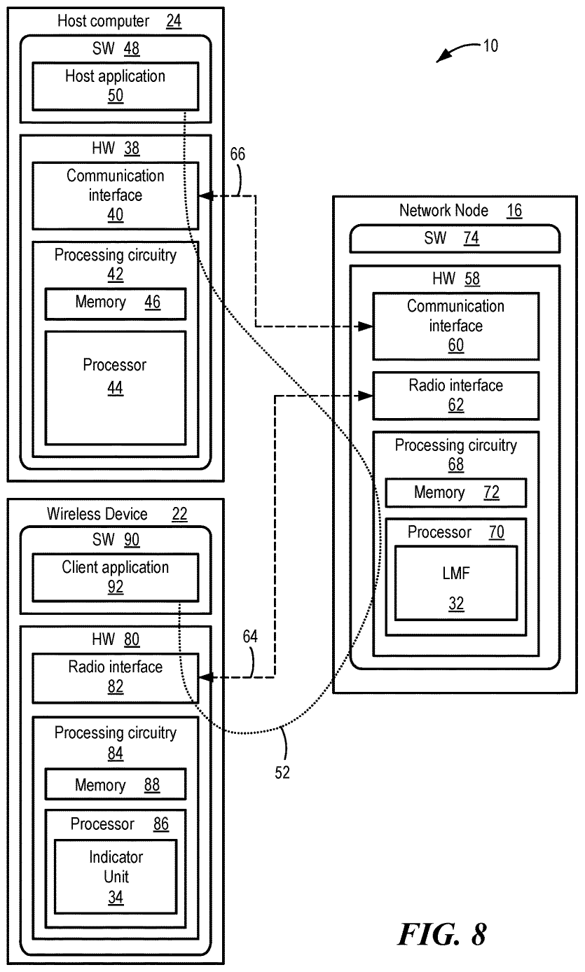

In some embodiments, the inner workings of the network node 16, WD 22, and host computer 24 may be as shown in FIG. 8 and independently, the surrounding network topology may be that of FIG. 7.

In FIG. 8, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 7 and 8 show various “units” such as LMF 32, and indicator unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

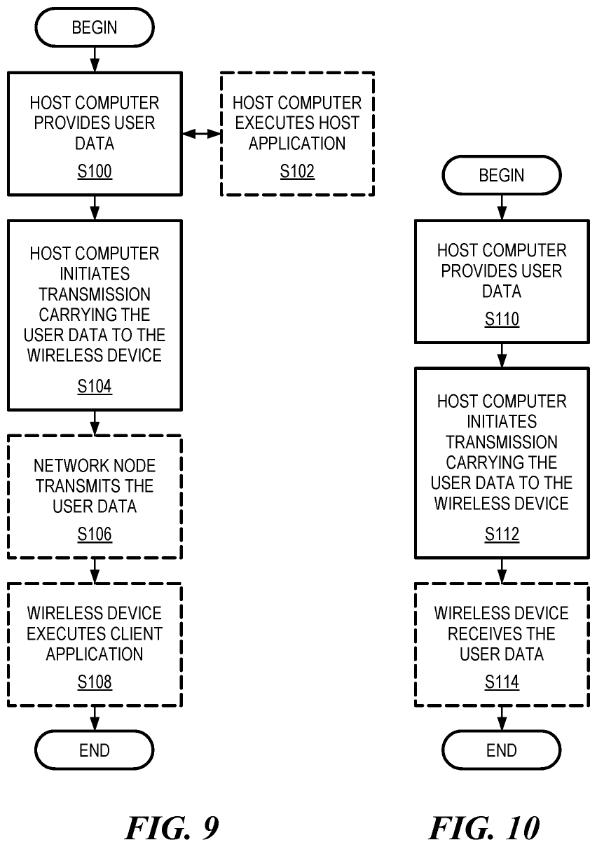

FIG. 9 is a flowchart illustrating an example method implemented in a communication system, such as, for example, the communication system of FIGS. 7 and 8, in accordance with one embodiment. The communication system may include a host computer 24, a network node 16 and a WD 22, which may be those described with reference to FIG. 8. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 10 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

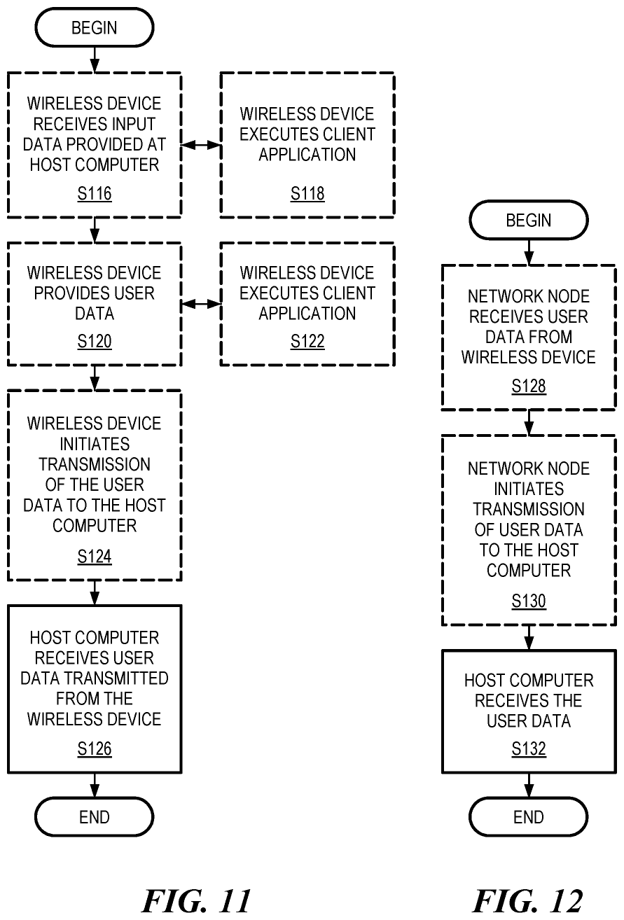

FIG. 11 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 12 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

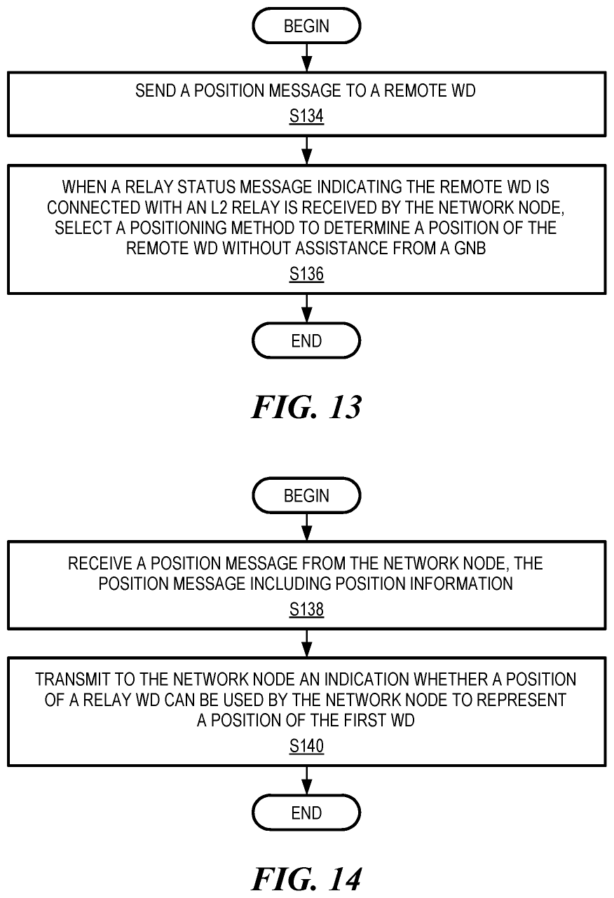

FIG. 13 is a flowchart of an example process in a network node 16 for indicating sidelink remote wireless device (WD 22a) during positioning, the network node 16 being configured to operate a location management function (LMF). One or more blocks described herein may be performed by one or more elements of network node 16 such as by one or more of processing circuitry 68 (including the LMF 32), processor 70, radio interface 62 and/or communication interface 60. Network node 16 such as via processing circuitry 68 and/or processor 70 and/or radio interface 62 and/or communication interface 60 is configured to send a position message to a remote WD 22a (Block S134). The method includes when a relay status message indicating the remote WD 22a is connected with an L2 relay is received by the network node, selecting a positioning process to determine a position of the remote WD 22a without assistance from a network node 16, e.g., gNB (Block S136).

In some embodiments, the selected positioning process includes determining a position of a relay WD 22b and estimating a position of the remote WD 22a based at least in part on the position of the relay WD 22b. In some embodiments, the method includes determining when the position of the relay WD 22b may be used to estimate the position of the remote WD 22a, based at least in part on at least one of position measurements, channel quality measurements of the sidelink channel between the remote WD 22a and the relay WD 22b, and a proximity indicator carried in the position message. In some embodiments, the estimated position of the remote WD 22a is the position of the relay WD 22b plus an offset. In some embodiments, the selected positioning method includes switching to a sidelink based positioning method. In some embodiments, the position message includes position information to enable the remote WD 22a to determine whether a position of a relay WD 22b may be used to estimate a position of the remote WD 22a. In some embodiments, the relay status message is received by a radio access node.

FIG. 14 is a flowchart of an example process in a wireless device 22 according to some embodiments of the present disclosure One or more blocks described herein may be performed by one or more elements of wireless device 22 such as by one or more of processing circuitry 84 (including the indicator unit 34), processor 86, radio interface 82 and/or communication interface 60. Wireless device 22 such as via processing circuitry 84 and/or processor 86 and/or radio interface 82 is configured to receive a position message from the network node, the position message including position information (Block S138). The process includes transmitting to the network node an indication whether a position of a relay WD 22b may be used by the network node to represent a position of the first WD (Block S140).

In some embodiments, the indication is based at least in part on a comparison of radio quality to a first threshold included in the position message. In some embodiments, the indication is based at least in part on a comparison of a distance to a second threshold included in the position message. In some embodiments, the network node is a gNB. In some embodiments, the first WD is a remote WD 22a. In some embodiments, the first WD is the relay WD 22b.

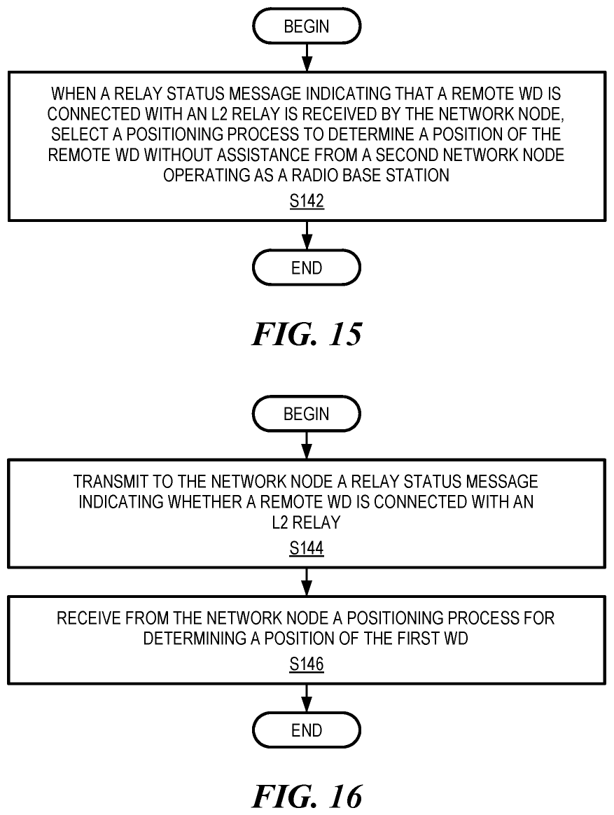

FIG. 15 is a flowchart of an example process in a network node 16 for indicating sidelink remote wireless device (WD 22a) during positioning, the network node 16 being configured to operate a location management function (LMF). One or more blocks described herein may be performed by one or more elements of network node 16 such as by one or more of processing circuitry 68 (including the LMF 32), processor 70, radio interface 62 and/or communication interface 60. Network node 16 such as via processing circuitry 68 and/or processor 70 and/or radio interface 62 and/or communication interface 60 is configured to operate a location management function, LMF. The method includes, when a relay status message indicating that a remote WD 22a is connected with an L2 relay is received by the network node, selecting a positioning process to determine a position of the remote WD 22a without assistance from a second network node operating as a radio base station (Block S142).

According to this aspect, in some embodiments the selected positioning process includes determining a position of a relay WD 22b and estimating a position of the remote WD 22a based at least in part on the position of the relay WD 22b. In some embodiments, the method includes determining when the position of the relay WD 22b may be used to estimate the position of the remote WD 22a, based at least in part on at least one of position measurements, channel quality measurements of a sidelink channel between the remote WD 22a and the relay WD 22b, and a proximity indicator. In some embodiments, the estimated position of the remote WD 22a is the position of the relay WD 22b plus an offset. In some embodiments, selecting the positioning process includes switching to a sidelink based positioning method. In some embodiments, the method includes transmitting position information to enable the remote WD 22a to determine whether a position of a relay WD 22b is to be used to estimate a position of the remote WD 22. In some embodiments, the relay status message is received from a radio access node. In some embodiments, the relay status message includes an indication of signal power of a sidelink connection between the remote WD 22a and a relay WD 22b. In some embodiments, the method includes determining one or both of a positioning accuracy and a positioning quality of service based at least in part on the signal power indication. In some embodiments, the method includes receiving the relay status message via an access and mobility management function, AMF, from the second network node operating as the radio base station.

FIG. 16 is a flowchart of an example process in a wireless device 22 according to some embodiments of the present disclosure One or more blocks described herein may be performed by one or more elements of wireless device 22 such as by one or more of processing circuitry 84 (including the indicator unit 34), processor 86, radio interface 82 and/or communication interface 60. Wireless device 22 such as via processing circuitry 84 and/or processor 86 and/or radio interface 82 is configured to transmit to the network node a relay status message indicating whether a remote WD 22a is connected with an L2 relay (Block S144). The process includes receiving from the network node a positioning process for determining a position of the first WD 22 (Block S146).

According to this aspect, in some embodiments, the relay status message is based at least in part on a comparison of radio quality to a first threshold. In some embodiments, the relay status message is based at least in part on a comparison of a distance to a second threshold. In some embodiments, the network node includes a radio base station. In some embodiments, the first WD 22 is a relay WD 22b.

Having described the general process flow of arrangements of the disclosure and having provided examples of hardware and software arrangements for implementing the processes and functions of the disclosure, the sections below provide details and examples of arrangements for indicating sidelink remote wireless device (WD 22a) during positioning.

The following embodiments assume that the discovery process of the remote WD 22a, establishing of the PC5 Relay connection via ProSe between the U2N Relay WD 22b and the remote WD 22a have already been done and that the remote WD 22a context is set up in the RAN Reference is made to the procedure from clause 6.11.1 of 3GPP TS 23.273.

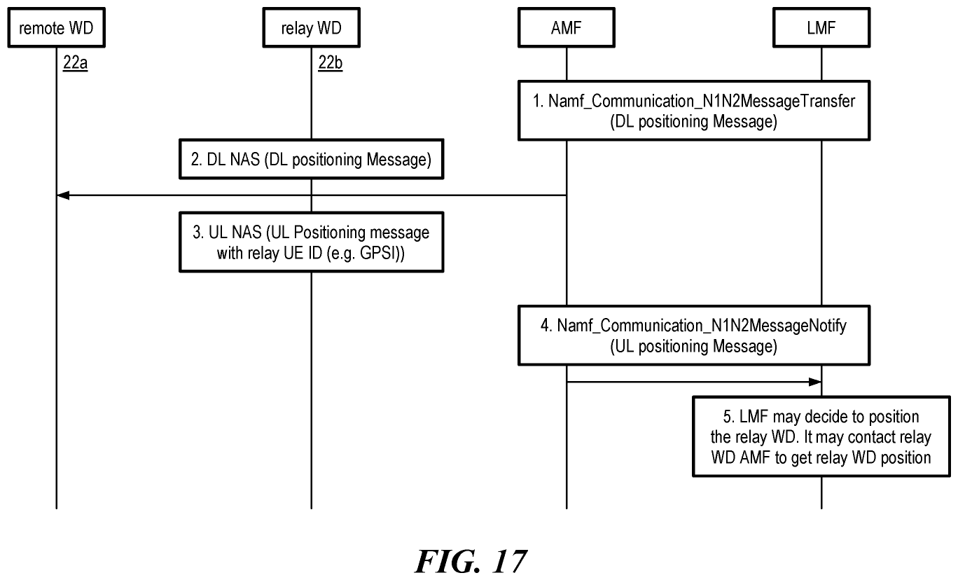

In FIG. 17, Step 3, a remote WD 22a sends an UL positioning message to the LMF, stating that the WD 22 is connecting via a L2 U2N relay. The WD 22 may also include the relay WD ID (e.g., GPSI) to the LMF. Upon reception of the message, the LMF may take at least one of the following actions to determine the position of the remote WD 22a:
Step 1: LMF determines whether the remote WD 22a may be positioned based on the position of the relay WD 22b, including which positioning capabilities are supported by the relay WD 22b;
Step 2: if the result of Step 1 is yes, LMF triggers a location procedure for the relay WD 22b; and/or
Step 3: LMF determines the position of the remote WD 22a is based on the position of the relay WD 22b.

In some embodiments, the LMF determines whether the relay WD's position may represent the position of the remote WD 22a according to at least one of the following

Global navigation satellite system (GNSS) position or measurement data of both WDs may indicate that the remote WD 22a is sufficiently close to the relay WD 22b so that the position of the remote WD 22a may be determined from the position of the relay WD 22b.

Radio channel quality measurement of the sidelink between the remote WD 22a and the relay WD 22b may indicate that the remote WD 22a is sufficiently close to the relay WD 22b. Radio channel quality may be measured in metrics including reference signal received power (RSRP), reference signal received quality (RSRQ), received signal strength indicator (RSSI), signal to interference plus noise ratio (SINR), signal to interference ratio (SIR), etc.

An indicator may be carried in the message indicating that the remote WD 22a and the relay WD 22b are sufficiently close, i.e., relay WD 22b is in proximity to WD 22a. The indicator may be a one bit indicator with the value “1” or “0”. In an example, the indicator with the value “1” indicates that the remote WD 22a is sufficiently close to the relay WD 22b, while the indicator with the value “0” indicates that the remote WD 22a is not sufficiently close to the relay WD 22b. In another example, the indicator with the value “0” indicates that the remote WD 22a is sufficiently close to the relay WD 22b, while the indicator with the value “1” indicates that the remote WD 22a is not sufficiently close to the relay WD 22. The indicator may be expressed as a physical distance. In some embodiments, a relay WD 22b is sufficiently close to the remote WD 22a that the position of the remote WD 22a may be based at least in part on the position of the relay WD 22b.

In some embodiments, the LMF may determine the position of the remote WD 22a from the relay WD's position plus an offset. The offset may be expressed in 1D domain (i.e., 1 dimensional coordination), 2D domain (i.e., 2-dimensional coordination) or 3D domain (i.e., 3-dimensional coordination).

In some embodiments, the LMF may send a positioning message to the remote WD 22a. The message may contain the information based at least in part on which the remote WD 22a may determine whether the relay WD's position may represent the remote WD's position.

The information may include a radio channel quality threshold of the sidelink between the remote WD 22a and the relay WD 22b. The relay WD's position may represent the remote WD's position if the measured radio channel quality is higher than the threshold The information may include a distance threshold between the remote WD 22a and the relay WD 22b. The relay WD's position may represent the remote WD's position if the actual distance between the remote WD 22a and the relay WD 22b is below the threshold.

In some embodiments, whether the relay WD's position may represent the remote WD's position is determined by the network node 16, e.g., gNB. The network node 16 may make the determination based at least in part on measurements, information provided by the remote WD 22a, the relay WD 22b or the core network entity (e.g., LMF or AMF). In some embodiments, network node 16 may be a core network node and serve as an LMF and/or AMF. Thus, references to LMF and AMF should be understood as implemented by a network node 16 as discussed herein and/or a core network node in the core network 14.

In some embodiments, the network node 16, e.g., gNB, may configure the remote WD 22a or the relay WD 22b with the information or configuration to assist the remote WD 22a or the relay WD 22b to determine whether the relay WD's position may represent the remote WD's position.

In some embodiments, the relay WD 22b determines whether the relay WD's position may represent the remote WD's position. In this case, the relay WD 22b may make the determination based at least in part on measurements, information provided by the remote WD 22a, the network node 16, e.g., gNB, or the core network entity (e.g., network node 16 operating an LMF or AMF or operating as an LMF or AMF).

In some embodiments, if the LMF determines that the remote WD 22a may not be positioned based at least in part on the position of the relay WD 22b, or by using RAN-based positioning methods in general, the LMF will consider using sidelink positioning based methods, or hybrid sidelink and RAN based method, to position the remote WD 22a using sidelink measurements.

In some embodiments, the U2N Relay WD 22b indicates to network whether the remote WD 22a may be positioned using SL positioning or hybrid U2N+SL positioning.

In some embodiments, remote WD 22a includes RSRP of the PC5 interface between the remote WD 22a and the relay in the UL positioning message to the LMF. LMF use the reference signal received power (RSRP) information to estimate the positioning quality of service (QoS) or accuracy, e.g., if it is OK to use the relay WD 22b position as the remote WD location according to the position QoS from the LCS client.

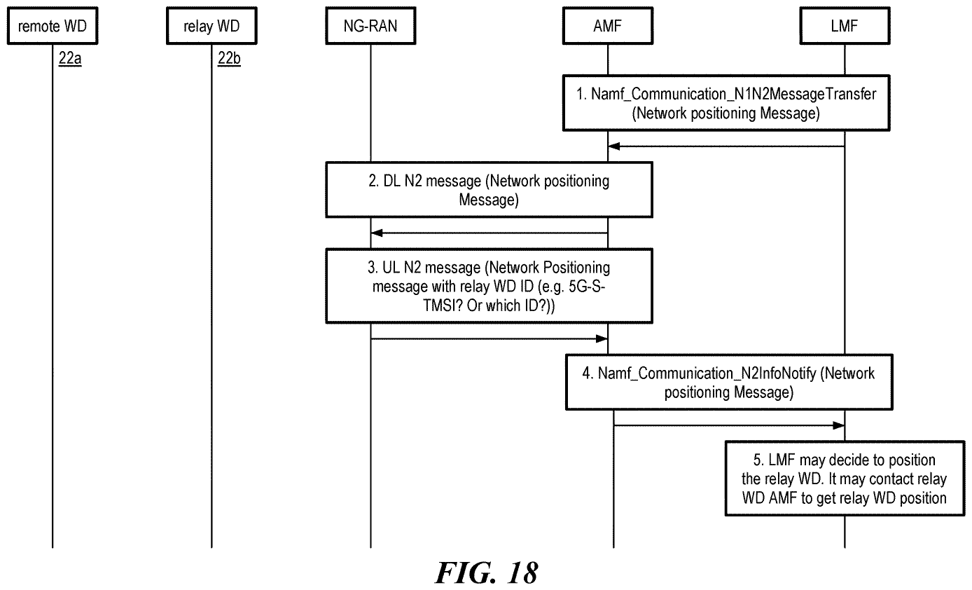

FIG. 18 is based on clause 6.11.2 of 3GPP TS 23.273.

In Step 2 of FIG. 18, the NG-RAN receives the Network positioning Message from the AMF. The NG-RAN knows that the WD 22 is connected via a L2 U2N relay, so the NG-RAN sends a response that includes the Network Positioning message back to the AMF, indicating that the WD 22 is connecting via a L2 U2N relay. The NG-RAN will also include the relay WD ID (the WD ID may be a local ID allocated by the network node 16, e.g., gNB, or the generic public subscription identifier (GPSI), or any other WD ID that may identify the U2N relay WD 22b to the LMF.

In some embodiments, the NG-application protocol (AP) message transporting the NR positioning protocol A (NRPPA) PDU in step 3 is used to signal to the AMF that a WD 22 for positioning is a remote WD/out of coverage WD 22 connected via a U2N Relay WD 22b.

In some embodiments, the remote WD 22a notifies the AMF using Non-Access Stratum (NAS) signaling that it is a remote WD 22a (as the remote WD 22a has NAS connection L2 relay) and informs the AMF as to which WD 22 it is currently associated to. The AMF based upon such info, if it may identify the remote WD 22a international mobile subscriber identity (IMSI), would inform the LMF or it may query the network node 16, e.g., gNB, using NG application protocol (NGAP).

In some embodiments, the network node 16, e.g., gNB, may inform the LMF using NRPPa; and the LMF may notify to the AMF that the WD 22 is a remote WD 22a. The AMF may use this info for different purposes such as informing a Gateway Mobile Location Center that the WD 22 is a remote WD 22a.

In some embodiments, the NGAP message from the network node 16, e.g., gNB, to the AMF containing the NRPPA PDU (i.e., the NRPPA Payload, e.g., UL WD ASSOCIATED NRPPA TRANSPORT message defined in 3GPP TS 38.413) may contain the Class 1 message, for example, an ERROR INDICATION message with a new NRPPA cause value indicating that a WD 22 is remote WD 22a (or e.g., out of coverage WD 22, partial coverage WD 22) and that Uu positioning is not possible for positioning such WD 22.

In some embodiments, the NG-RAN node sends the updated information, for example, an indicator, in an NG-AP message, to inform AMF that the remote WD 22a is no longer connected via a relay WD 22b but directly to network node 16, e.g., gNB, which means the Uu positioning becomes possible.

Upon receiving such message, the LMF may decide to either consider remote WD's position to be estimated via U2N Relay WD's position,—or the LMF may consider SL positioning measurements as a means for positioning remote WD 22a—or to use hybrid SL and Uu positioning measurements.

In another separate embodiment, the information on the U2N relay WD 22b that is connected to the target remote WD 22a for positioning is signaled in the NG-RAN between the gNB-DU and the gNB-CU in case of split gNB. Such information may contain the ID of the relay WD 22b, its connectivity status and the PC5 measurements collected from the remote WD 22a that may be used for positioning purpose, which may be included in the RRC containers.

Some embodiments may include one or more of the following:

Embodiment A1. A network node configured to communicate with a wireless device (WD), the network node configured to operate a location management function (LMF), the network node further configured with a radio interface and/or processing circuitry configured to:
send a position message to a remote WD; and
when a relay status message indicating that the remote WD is connected with an L2 relay is received by the network node, select a positioning process to determine a position of the remote WD without assistance from a network node operating as a gNB.

Embodiment A2. The network node of Embodiment A1, wherein the selected positioning process includes determining a position of a relay WD and estimating a position of the remote WD based at least in part on the position of the relay WD.

Embodiment A3. The network node of Embodiment A2, wherein the processing circuitry is further configured to determine when the position of the relay WD may be used to estimate the position of the remote WD, based at least in part on at least one of position measurements, channel quality measurements of the sidelink channel between the remote WD and the relay WD, and a proximity indicator carried in the position message.

Embodiment A4. The network node of any of Embodiments A2 and A3, wherein the estimated position of the remote WD is the position of the relay WD plus an offset.

Embodiment A5. The node of any of Embodiments A1-A4, wherein the selected positioning process includes switching to a sidelink based positioning method.

Embodiment A6. The network node of any of Embodiments A1-A5, wherein the position message includes position information to enable the remote WD to determine whether a position of a relay WD may be used to estimate a position of the remote WD.

Embodiment A7. The network node of any of Embodiments A1-A6, wherein the relay status message is received from a radio access node.

Embodiment B1. A method implemented in a network node configured to communicate with a wireless device (WD), the network node configured to operate a location management function (LMF), the method comprising:
sending a position message to a remote WD; and
when a relay status message indicating that the remote WD is connected with an L2 relay is received by the network node, selecting a positioning process to determine a position of the remote WD without assistance from a network node operating as a gNB.

Embodiment B2. The method of Embodiment B1, wherein the selected positioning process includes determining a position of a relay WD and estimating a position of the remote WD based at least in part on the position of the relay WD.

Embodiment B3. The method of Embodiment B2, further comprising determining when the position of the relay WD may be used to estimate the position of the remote WD, based at least in part on at least one of position measurements, channel quality measurements of the sidelink channel between the remote WD and the relay WD, and a proximity indicator carried in the position message.

Embodiment B4. The method of any of Embodiments B2 and B3, wherein the estimated position of the remote WD is the position of the relay WD plus an offset.

Embodiment B5. The method of any of Embodiments B1-B4, wherein the selected positioning process includes switching to a sidelink based positioning method.

Embodiment B6. The method of any of Embodiments B1-B5, wherein the position message includes position information to enable the remote WD to determine whether a position of a relay WD may be used to estimate a position of the remote WD.

Embodiment B7. The method of any of Embodiments B1-B6, wherein the relay status message is received from a radio access node.

Embodiment C1. A first wireless device (WD) configured to communicate with a network node operating a location management function (LMF), the first WD configured to, and/or comprising a radio interface and/or processing circuitry configured to:
receive a position message from the network node, the position message including position information; and
transmit to the network node an indication whether a position of a relay WD may be used by the network node to represent a position of the first WD.

Embodiment C2. The first WD of Embodiment C1, wherein the indication is based at least in part on a comparison of radio quality to a first threshold included in the position message.

Embodiment C3. The first WD of any of Embodiments C1 and C2, wherein the indication is based at least in part on a comparison of a distance to a second threshold included in the position message.

Embodiment C4. The first WD of any of Embodiments C1-C3, wherein the network node is a gNB.

Embodiment C5. The first WD of any of Embodiments C1-C4, wherein the first WD is a remote WD.

Embodiment C6. The first WD of any of Embodiments C1-C4, wherein the first WD is the relay WD.

Embodiment D1. A method implemented in a first wireless device (WD) configured to communicate with a network node operating a location management function (LMF), the method comprising:
receiving a position message from the network node, the position message including position information; and
transmitting to the network node an indication whether a position of a relay WD may be used by the network node to represent a position of the first WD.

Embodiment D2. The method of Embodiment D1, wherein the indication is based at least in part on a comparison of radio quality to a first threshold included in the position message.

Embodiment D3. The method of any of Embodiments D1 and D2, wherein the indication is based at least in part on a comparison of a distance to a second threshold included in the position message.

Embodiment D4. The method of any of Embodiments D1-D3, wherein the network node is a gNB.

Embodiment D5. The method of any of Embodiments D1-D4, wherein the first WD is a remote WD.

Embodiment D6. The method of any of Embodiments D1-D4, wherein the first WD is the relay WD.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| | |
|---|---|
| LCS | LoCation Service |
| LMF | Location Management Function |
| MT-LR | Mobile Terminated Location Request |
| ProSE | Proximity Services |
| UE | User Equipment |
| WD | Wireless Device |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-30. (canceled)

31. A first network node configured to:
receive, from a radio access node, a first message indicating that a wireless device is connected to the radio access node via a layer two, L2, relay wireless device; and
transmit, to a second network node, a second message indicating that the wireless device is connected via the L2 relay wireless device.

32. The first network node of claim 31, wherein the first network node is further configured to perform positioning of the wireless device via a non-radio access network-based positioning process due to the wireless device being connected with the L2 relay wireless device.

33. The first network node of claim 32, wherein the non-radio access network-based positioning process comprises:
a sidelink based positioning process; or
a positioning process that uses the L2 relay wireless device's position to estimate the wireless device's position.

34. The first network node of claim 33, wherein the first network node is further configured to transmit, to the second network node, a positioning message that requests a transfer of a network positioning message to the radio access node; and
the first message is associated with the network positioning message.

35. The first network node of any one of claim 34, wherein the network positioning message is configured to request, from the radio access node, positioning information associated with the wireless device.

36. The first network node of claim 31, wherein the first message is received using New Radio Positioning Protocol A, NRPPa.

37. The first network node of claim 31, wherein the first network node is a core network node.

38. The first network node of claim 37, wherein the core network node is a location management function, LMF, node.

39. The first network node of claim 38, wherein the second network node is one of an Access and Mobility Management Function, AMF, node, Gateway Mobile Location Centre, GMLC, node or second LMF node.

40. The first network node of claim 31, wherein the first network node is further configured to transmit, to the second network node, a positioning message that requests a transfer of a network positioning message to the radio access node; and
the first message is associated with the network positioning message.

41. The first network node of claim 31, wherein the first network node is a location management function, LMF, node; and
the second network node is a second LMF node.

42. A radio access node configured to:
receive a positioning message that requests positioning information associated with a wireless device; and
transmit, to a first network node, a first message indicating that a wireless device is connected to the radio access node via a layer two, L2, relay wireless device.

43. The radio access node of claim 42, wherein the first message is received using New Radio Positioning Protocol A, NRPPa.

44. The radio access node of claim 43, wherein the first network node is a core network node.

45. The radio access node of claim 42, wherein the positioning message is received from a second network node.

46. The radio access node of claim 45, wherein the radio access node is further configured to transmit, to the second network node, an indication that the wireless device is no longer connected via the L2 relay wireless device and is directly connected to the radio access node.

47. The radio access node of claim 46, wherein the first network node is a location management function, LMF, node; and
the second network node is one of an Access and Mobility Management Function, AMF, node, Gateway Mobile Location Centre, GMLC, node or second LMF node.

48. The radio access node of claim 42, wherein the first network node is a core network node.

49. The radio access node of claim 42, wherein the positioning message is received from a second network node; and
the radio access node is further configured to transmit, to the second network node, an indication that the wireless device is no longer connected via the L2 relay wireless device and is directly connected to the radio access node.

50. The radio access node of claim 42, wherein the first network node is a location management function, LMF, node.
